(19) United States
(12) Patent Application Publication
(10) Pub. No.: US 2009/0226706 A1
(43) Pub. Date: Sep. 10, 2009

(54) Doctor blade and method for manufacture of doctor blade

(75) Inventors: Marko Kristian Maja, Saynatsalo (FI); Heikki Toivanen, Jyvaskyla (FI); Ari Telama, Jyvaskyla (FI); Mika Immonen, Jyvaskyla (FI); Kowit Patimaporntap, Bangkok (TH)

Correspondence Address: OLIFF & BERRIDGE, PLC, P.O. BOX 320850, ALEXANDRIA, VA, 22320-4850, US

(73) Assignee: METSO PAPER, INC., Helsinki (FI)

(21) Appl. No.: 12/379,794

(22) Filed: Mar. 2, 2009

(30) Foreign Application Priority Data
Mar. 6, 2008 (FI) 20085212

(51) Int. Cl. B32B 5/16; B32B 5/02; C08K 3/34; B05D 3/00

(52) U.S. Cl. 428/323; 524/1; 428/368; 524/450; 427/372.2; 427/547; 427/532; 977/742

(57) ABSTRACT

The invention concerns a doctor blade of a fiber web machine, where the doctor blade is of a composite structure comprising a fiber material as reinforcement, and a binder. The reinforcement in the composite structure is essentially composed of a fiber material which is free from carbon fiber and the composite structure comprises particulate carbon in order to improve the thermal conductivity of the doctor blade.

The invention concerns a doctor blade in accordance with the preamble of claim 1 and a method for the manufacture of a doctor blade in accordance with the preamble of claim 9.

Prior art solutions include doctor blades manufactured from a resin matrix and provided with fiber reinforcement. Commonly used fibers include fiberglass and carbon fiber as reinforcements in polymer resin. Doctor blades are commonly used on fiber web machines for example to clean roll surfaces, and on tissue machines to remove the web from the Yankee dryer. Corresponding blades can also be used on roll coating stations to apply the coating agent.

Publication FI 117568 describes a doctor blade which comprises fiber weaves laminated on top of each other, for example fiberglass weaves. The publication presents that on the surface that finishes at the blade edge or in its vicinity, there is a fiber weave coated with hard particles. According to the publication, keeping the blade edge sharp can be contributed to by having a thin carbon fiber mat on the surface or in its direct vicinity, but no carbon fiber is needed in the other parts of the blade structure. In such a solution, the blade heats up excessively and hence wears rapidly.

Publication WO 2005124019 describes a doctor blade or other planar element intended to be used on a paper machine, where the element comprises a synthetic structure, including nanoparticles in a polymer resin matrix. According to the publication, the nanoparticles can be for example a carbon nanotube. According to the publication, the nanoparticles can constitute 0.5 to 75 percent of the weight of the matrix, but most preferably 10 to 15 percent, and they can accomplish for example improved strength and wearing properties of the structure. The publication also presents the use of carbon fiber in the structure.

Publication WO2007030392 A1 describes a doctor blade intended to be used on paper machines, where the blade is a layered composite, where at least some of the layers contain basalt fibers. According to the publication, basalt fibers are more grinding than carbon fibers and more durable than fiberglass, and they cause a smaller friction force. However, the thermal conductivity of basalt fiber does not differ significantly from fiberglass, which is why a doctor blade reinforced with basalt fibers alone wears very rapidly.

Publication DE 102005038652 A1 describes a doctor blade solution, where the composite material matrix contains a nanomaterial, such as carbon fiber, carbon, fullerene or nanotubes, used as a filler material. According to the publication, the nanomaterial can be such that through its addition, the thermal conductivity of the composite material increases for example from 0.5-1 W/mK to over 2 W/mK. According to the publication, the reinforcement material itself can be carbon fiber.

An elevated temperature at the tip of the doctor blade, caused by friction, is considered to be one of the main reasons for the wear of doctor blades. Publication FI 101637 describes a doctor blade which comprises several fiber layers in a laminate structure, with at least one carbon fiber layer or layer essentially containing carbon fiber, where this layer contains grinding particles in direct vicinity of the carbon fibers and where the orientation of the carbon fibers is substantially diverging from the longitudinal axis of the blade, preferably in the cross direction of the blade, in order to promote the transfer of heat away from the tip of the blade.

However, carbon fiber has limited availability, and it is a relatively expensive raw material for a wearing part such as a doctor blade, which is why there is a need to replace the carbon fiber while at the same time at least retaining the thermal conductivity properties of the doctor blade or even improving these properties.

The object of the present invention is a doctor blade in accordance with the preamble of claim 1, where the wear of the doctor blade is minimized in operation and where the problems of prior art solutions are minimized.

This object is primarily achieved so that the reinforcement in the composite structure of the doctor blade is essentially composed of a fiber material which is free from carbon fiber, and so that the composite structure comprises particulate carbon in order to improve the thermal conductivity of the doctor blade.

In accordance with the present invention, the fiber material used is preferably a fiber material essentially free from carbon fiber so that at least most of the reinforcement function of the fiber material is achieved by means of a fiber material which is totally free from carbon fiber. When the proportion of carbon fiber in the fiber material is less than 10 percent, the thermal conductivity of the fiber material is not significantly great. The fiber material is preferably basalt fiber. In this way, the strength properties and thermal conductivity of the doctor blade material can be designed and selected essentially irrespective of each other.

In accordance with one embodiment of the invention, the composite structure comprises carbon particles arranged in concentrations so that the orientation of the concentrations is essentially diverging from the longitudinal direction of the doctor blade.

The object of the present invention is a method in accordance with the preamble of claim 9, with which method it is possible to manufacture a doctor blade whose wear is minimized in operation.

This object is primarily achieved so that the fiber material used in the composite structure of the doctor blade is impregnated by means of a matrix material, and after this the composite structure is hardened, and that the fiber material is essentially free from carbon fiber and that particulate carbon is added to the composite structure before the composite structure is hardened.

The other additional characteristic features of the invention are disclosed in the enclosed patent claims.

The particulate carbon can comprise or consist of fullerenes or carbon nanotubes. Fullerene is a spherical molecule, usually consisting of 60 carbon atoms. A carbon nanotube is a molecule consisting of carbon atoms, with the length of the molecule being up to one millimeter. The particulate carbon can also be of chip type.

Several benefits are achieved with the invention. Carbon fiber is no longer needed to accomplish good thermal conductivity in the doctor blade, and the overall strength of the doctor blade can be improved over prior art doctor blades.

In what follows, the invention and its functioning is described by making reference to the enclosed schematic figures, where:

FIG. 1 is a doctor blade in accordance with one embodiment of the invention,

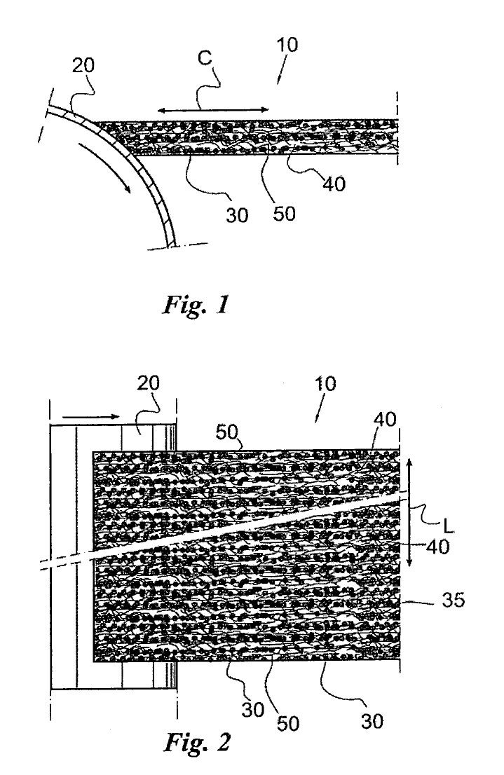

FIG. 2 is a top view of the doctor blade of FIG. 1,

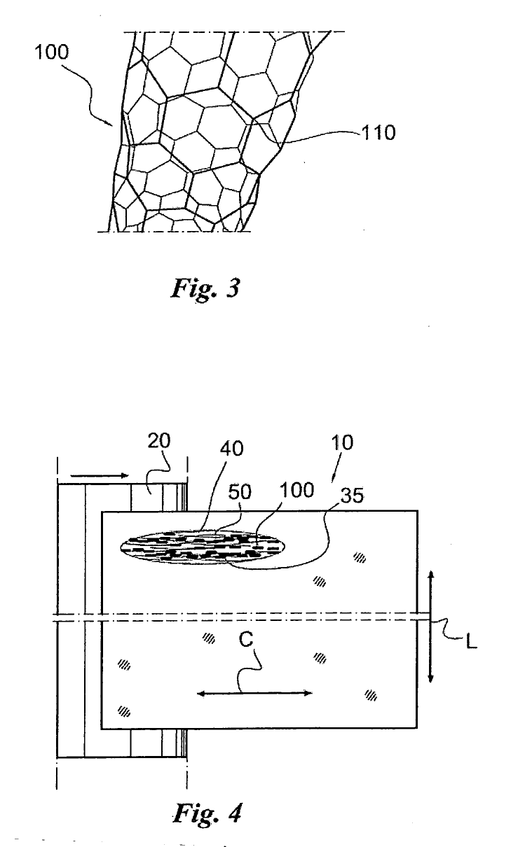

FIG. 3 is an example of the structure of a carbon nanotube,

FIG. 4 is a doctor blade in accordance with another embodiment of the invention, and

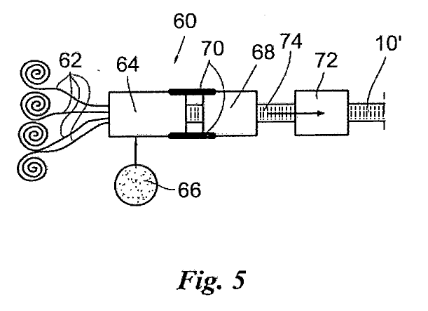

FIG. 5 is one embodiment of the method in accordance with the invention for the manufacture of the doctor blade.

FIGS. 1 and 2 show a schematic view of the doctor blade 10 in accordance with one embodiment of the invention. The doctor blade is presented here in operation in conjunction with the surface of a roll or cylinder 20 of a fiber web machine. In operation, the roll or cylinder rotates in the direction indicated by the arrow, whereby the surface of the roll or cylinder 20 moves against the blade under it. The blade is supported by parts (not presented), with which a force that presses the blade against the surface can be exerted on the blade.

The doctor blade 10 is primarily a fiber-reinforced plastic or polymer of a composite structure, and it is composed of a fiber material 50 and a binder 40, which binds the fiber material and which can also be referred to as a matrix in this conjunction. The fiber material is the reinforcement of the composite structure. The matrix 40 is typically of a suitable resin or thermoplastic. The fiber material can be for example a weave, or it can be of a non-woven material.

The thickness of the doctor blade 10 is typically approx. 1.5-2.5 mm, and it contains several fiber layers on top of each other, typically 6-12 layers. In accordance with the invention, the fiber material used is preferably a fiber material which is essentially free from carbon fiber so that at least most of the reinforcement function of the fiber material is achieved by means of a fiber material which is totally free from carbon fiber. When the proportion of carbon fiber in the fiber material is less than 10 percent, the thermal conductivity of the fiber material is not significantly great. The fiber material contains mainly basalt fiber, which has a relatively low thermal conductivity. The fiber material may also comprise a combination or mixture of fiberglass and basalt fiber. The composite structure also comprises particulate carbon 30.

The use of a fiber material which is free from carbon fiber together with particulate carbon 30 accomplishes a preferable entity even though the fibers free from carbon fiber do not conduct heat significantly and hence, even though the amount of particulate carbon has to be sufficient in order to achieve efficient thermal conductivity away from the tip of the doctor blade along the blade structure, the structure becomes sufficiently strong owing to the fibers. In this way, the thermal conductivity and strength of the doctor blade can be kept separate issues, and hence there is more latitude in the design of the structure in terms of these properties.

Especially the use of basalt fibers together with particulate carbon results in a preferable entity. The basalt fibers do not conduct heat significantly, either, but because basalt fibers result in an especially strong composite structure and hence, even though the amount of particulate carbon has to be sufficient in order to achieve efficient thermal conductivity away from the tip of the doctor blade, the structure becomes sufficiently strong specifically owing to the basalt fibers. The mutual proportions of the fiber material, binder and particulate carbon are chosen so that the thermal conductivity of the composite structure in the cross direction of the doctor blade is preferably at least 100 W/mK.

The amount of particulate carbon in the matrix is preferably more then 10 percent but less than approx. 50 percent. The lower limit is determined by the fact that carbon particles have been found to form flocs, or concentrations, at proportions above the said 10 percent limit. The formation and presence of carbon flocs raises the thermal conductivity of the composite structure considerably. On the other hand, the said upper limit is determined by the ability of the matrix to function sufficiently well as a binder, and the upper limit therefore depends to a great extent on the reinforcement used.

When the particulate carbon is a carbon nanotube, the nanotubes also form carbon concentrations, as a result of which the thermal conductivity is improved.

The durability of the doctor blade can be increased further by using a polymer with a high glass transition temperature, such as epoxy, technical thermoplastics such as PEEK (polyetheretherketone), as the matrix. These materials allow the temperature of the blade to rise relatively high without significant melting of the matrix to begin.

FIG. 3 presents an example of the structure of the carbon nanotube 100. It is a tube-like structure consisting of carbon atoms 110, where the carbon atoms are grouped into hexagons so that each carbon atom is attached to three adjacent carbon atoms. The length of the carbon nanotube can be of a magnitude up to a millimeter. In one preferred embodiment of the invention, the particulate carbon is a carbon nanotube. The structure of the doctor blade 10 in accordance with this embodiment is presented in partial section of the surface of the blade in FIG. 4. Since the size of the carbon nanotubes is very small, the carbon amount needed to accomplish sufficient thermal conductivity can be achieved more easily using carbon nanotubes. The very small carbon nanotubes are placed more easily into various cavities and similar locations in the matrix and fibers, and therefore the amount of carbon can be increased more easily to the necessary level without having to make unnecessary compromises in the amount of fiber or matrix.

In the doctor blade of the invention, the carbon is preferably in flocs, or concentrations, formed by carbon particles, which improves thermal conductivity significantly. The particulate carbon, carbon nanofiber and/or concentrations 35 formed by these are preferably oriented so that their primary direction is essentially divergent from the longitudinal direction L of the doctor blade, preferably in the cross direction C of the doctor blade. Similarly, in the embodiment where the particulate carbon is a carbon nanotube, the direction of the carbon nanotubes 100 is correspondingly essentially divergent from the longitudinal direction L of the doctor blade 10. With this orientation, the heat-conducting feature of carbon can be employed more efficiently, and therefore the amount of carbon is not unnecessarily great.

The doctor blade can be manufactured using the pultrusion method, for example. FIG. 5 presents one example of the method in accordance with the invention for manufacturing a composite plate-like blade 10. The blade 10 in accordance with the invention is manufactured at least partially using pultrusion technology in process 60. The pultrusion method 60 as such represents prior art technique, so it is not necessary to describe it in great detail in this conjunction. In the method, fiber mats or weaves 62 are pulled in the pulling section 72 (the pulling direction is indicated by the arrow) through the basic phases characteristic of the pultrusion method, as result of which a blade blank 10′ is formed, and the final blade can be made from such blank. The fibers/fiber mats/fiber weaves 62 are first taken into an impregnation section 64, where the fibers are impregnated or wetted in some selected matrix material, into which the particulate carbon has been added in accordance with the invention in the matrix material treatment section 66 preceding the impregnation section. The fiber material and the yet unhardened matrix are subjected to an electric or magnetic field by means of a section 70 which is arranged in conjunction with the device and which induces an electric or magnetic field. As a result of the electric or magnetic field, the particulate carbon and concentrations in the matrix are oriented 74 in this way divergent from the longitudinal direction L of the blade blank 10′ and hence also from the longitudinal direction L of the doctor blade, essentially in the cross direction of the doctor blade. In the next phase on the hardening section 68, the matrix in the composite is hardened. The section 70 which accomplishes the electric or magnetic field can extend to the region of the matrix hardening section. Pultrusion is not the only manufacturing method for the manufacture of the doctor blade in accordance with the invention. Other possible manufacturing methods include lamination and compression at an elevated pressure and temperature.

In accordance with another embodiment of the invention, carbon particles are arranged as concentrations in the composite structure, where the orientation of the concentrations is essentially divergent from the longitudinal direction of the doctor blade, so that at least some of the fiber material used has been coated with particulate carbon before the impregnation of the matrix and so that the orientation of the coated fibers in the fiber material is primarily such that upon pultrusion it settles in cross direction in the doctor blade with respect to the longitudinal direction of the doctor blade.

It is to be noted that what has been described above only includes some most preferred embodiments of the invention. It is therefore clear that the invention is not limited to the above embodiments alone, but it can be applied in many ways within the enclosed patent claims. The features described in conjunction with the various embodiments can also be used in conjunction with the other embodiments within the basic idea of the invention and/or various entities can be combined of the features presented if this is to be desired and because the technical facilities for this exist.

1. Doctor blade of a fiber web machine, where the doctor blade is of a composite structure comprising a fiber material as reinforcement and a binder, wherein the reinforcement in the composite structure is essentially composed of a fiber material which is free from carbon fiber and that the composite structure comprises particulate carbon in order to improve the thermal conductivity of the doctor blade.

2. A doctor blade as claimed in claim 1, wherein the thermal conductivity of the composite structure composed of the fiber material which is essentially free from carbon fiber, and binder and particulate is essentially at least 100 W/mK in the cross direction of the doctor blade.

3. A doctor blade as claimed in claim 1, wherein the composite structure comprises particulate carbon arranged in concentrations so that the orientation of the concentrations is essentially diverging from the longitudinal direction of the doctor blade.

4. A doctor blade as claimed in claim 1, wherein the particulate carbon is arranged in the composite structure as a coating on the fibers in the fiber material.

5. A doctor blade as claimed in claim 1, wherein the binder is a polymer with a high glass transition temperature.

6. A doctor blade as claimed in claim 1, wherein the particulate carbon comprises carbon nanotubes.

7. A doctor blade as claimed in claim 1, wherein the fiber material which is free from carbon fiber comprises basalt fiber.

8. A doctor blade as claimed in claim 7, wherein the fiber material which is free from carbon fiber is composed of basalt fiber and/or fiberglass.

9. A method for the manufacture of the doctor blade of a fiber web machine, where the fiber material used in the composite structure of the doctor blade is impregnated by means of a matrix material and after this the composite structure is hardened, wherein the fiber material is essentially free from carbon fiber and that particulate carbon is added to the composite structure before the composite structure is hardened.

10. A method as claimed in claim 9, wherein the particulate carbon is made to orient primarily in the cross direction of the doctor blade before the matrix is hardened.

11. A method as claimed in claim 10, wherein the particulate carbon is made to orient primarily in the cross direction of the doctor blade so that a directed magnetic field is exerted on the composite structure before the matrix is hardened.

12. A method as claimed in claim 10, wherein the particulate carbon is made to orient primarily in the cross direction of the doctor blade so that a directed electric field is exerted on the composite structure before the matrix is hardened.
